(19) United States
(12) Patent Application Publication
(10) Pub. No.: US 2025/0381671 A1
(43) Pub. Date: Dec. 18, 2025

(54) EQUIPMENT LAYOUT ADJUSTMENT SYSTEM AND EQUIPMENT LAYOUT ADJUSTMENT METHOD

(71) Applicant: Hitachi, Ltd., Tokyo (JP)

(72) Inventors: Kaoru KITAJIMA, Tokyo (JP); Daisuke TSUTSUMI, Tokyo (JP); Hiroki TAKEDA, Tokyo (JP)

(21) Appl. No.: 19/228,842

(22) Filed: Jun. 5, 2025

(30) Foreign Application Priority Data
Jun. 14, 2024 (JP) 2024-096778

(51) Int. Cl. B25J 9/16

(52) U.S. Cl. CPC B25J 9/1664; B25J 9/163

(57) ABSTRACT

An equipment layout adjustment system includes a calculation device and a storage device. The storage device holds position and posture constraint information indicating a constraint on a position and a posture of an object. The object includes at least a robot, a work target object that is a target on which the robot performs work, and a work-related object that constrains a position and a posture of the work target object. The calculation device selects, based on the position and posture constraint information, a decision variable to be subjected to calculation for optimization of an objective function of evaluating an operation of the robot from among variables indicating the position and the posture of the object, calculates a trajectory of the robot based on the decision variable, and specifies, based on the calculated trajectory of the robot, a value of the decision variable so as to optimize the objective function.

### CLAIM OF PRIORITY

The present application claims priority from Japanese patent application JP 2024-096778 filed on Jun. 14, 2024, the content of which is hereby incorporated by reference into this application.

### TECHNICAL FIELD

The present invention relates to a technique for adjusting a layout of equipment items including a robot.

### BACKGROUND ART

As a technique for design of a system including a robot as a component, for example, there is a technique described in Japanese Unexamined Patent Application Publication No. 2022-134604 (Patent Literature 1).

Patent Literature 1 describes that “in the design of a robot cell system, the arrangement of a robot and each member and the operation of the robot need to be appropriately designed so that the operation time of the system falls within a target time. A technique for supporting the design of such a robot cell system has been proposed”.

### CITATION LIST

### Patent Literature

Patent Literature 1: Japanese Unexamined Patent Application Publication No. 2022-134604

### SUMMARY OF INVENTION

### Technical Problem

In the technique described in Patent Literature 1 described above, a candidate for arrangement of members other than the robot of the robot cell system is calculated, and a candidate for the arrangement of the members is evaluated based on a result of planning a route for the robot. Members involved in the planning of the route for the robot include not only work targets on which the robot performs work, such as a workpiece and a component supply machine, but also a worktable and a conveyor on which the work targets are placed, and thus the amount of calculation required in a real environment is enormous.

Therefore, the present invention provides an equipment layout adjustment system capable of reducing the amount of calculation while considering not only a work target but also arrangement of components related to the work target.

### Solution to Problem

The present specification includes a plurality of means for solving at least a part of the above problems, and examples of the means are as follows.

According to an aspect of the present invention, an equipment layout adjustment system includes a calculation device and a storage device. The storage device holds position and posture constraint information indicating a constraint on a position and a posture of an object. The object includes at least a robot, a work target object that is a target on which the robot performs work, and a work-related object that constrains a position and a posture of the work target object. The calculation device selects, based on the position and posture constraint information, a decision variable to be subjected to calculation for optimization of an objective function of evaluating an operation of the robot from among variables indicating the position and the posture of the object, calculates a trajectory of the robot based on the decision variable, and specifies, based on the calculated trajectory of the robot, a value of the decision variable so as to optimize the objective function.

### Advantageous Effects of Invention

According to the present invention, it is possible to provide a technique for adjusting a layout of equipment items including a robot in a simple manner.

Objects, configurations, and effects other than the above will be apparent from the description of the following embodiments.

### BRIEF DESCRIPTION OF DRAWINGS

FIG. 1 is a diagram illustrating an example of a configuration of an equipment layout adjustment system.

FIG. 2 is a diagram illustrating an example of equipment information stored in an equipment information storage unit.

FIG. 3 is a diagram illustrating an example of position and posture constraint information stored in a position and posture constraint information storage unit.

FIG. 4 is a diagram illustrating an example of decision variables stored in a decision variable storage unit.

FIG. 5 is a diagram illustrating an example of a robot's trajectory stored in a robot trajectory storage unit.

FIG. 6 is a flowchart illustrating an example of an equipment layout adjustment process.

FIG. 7 is a flowchart illustrating an example of a decision variable selection process.

FIG. 8 is a diagram illustrating an example of coordinate transformation from robot coordinates to a target point using decision variables.

FIG. 9 is a diagram illustrating an example of display screens output by an output device.

### DESCRIPTION OF EMBODIMENTS

In the following embodiments, for convenience, when necessary, a description will be divided into multiple sections or embodiments. However, unless otherwise expressly stated, they are not unrelated to each other, and one of the sections or embodiments is a partial or complete modification, details, supplementary explanation, or the like of the other of the sections or embodiments.

In addition, in the following embodiments, when referring to the number of elements and the like (including the number, a value, a quantity, a range, and the like), unless specifically stated or clearly limited to a specific number in principle, the number is not limited to the specific number and may be greater than or equal to the specific member or may be less than or equal to the specific number.

Further, in the following embodiments, needless to say, the constituent elements (including element steps and the like) are not necessarily essential unless otherwise specified or considered to be clearly essential in principle.

Similarly, in the following embodiments, when referring to the shapes, positional relationships, and the like of the constituent elements and the like, it is assumed that the components include components having shapes and the like substantially similar or approximate to those shapes and the like, unless otherwise specified or considered to be clearly different in principle. The same applies to the above-described value and the range.

In addition, in all of the drawings for explaining the embodiments, the same members are generally given the same reference signs, and repeated explanations thereof will be omitted. However, even if members are the same, when there is a high possibility of confusion that occurs if the names of the members are shared with those of the members before a change due to an environmental change or the like, different signs or names may be used.

Each embodiment of the present invention will be described with reference to the drawings.

In the present embodiment, an equipment layout adjustment system that adjusts an input initial layout and presents the adjusted layout to a user who requires an equipment layout that improves evaluation of a robot operation represented by a cycle time.

In the following embodiments, an “input device” and an “output device” may be one or more interface devices. The one or more interface devices may be one of the following devices.

### One or More I/O (Input/Output) Interface Devices

Each of the one or more I/O interface devices is an interface device for at least one of an I/O device and a remote display computer. The I/O interface device for the display computer may be a communication interface device. At least one I/O device may be any one of user interface devices, for example, input devices, such as a keyboard and a pointing device, and an output device such as a display device.

### One or More Communication Interface Devices

The one or more communication interface devices may be one or more communication interface devices (for example, one or more network interface cards (NICs) of the same type, or may be two or more communication interface devices (for example, an NIC and a host bus adapter (HBA)) of different types.

In addition, in the following description, a “memory” is one or more memory devices, which are an example of one or more storage devices, and may be typically a main storage device. At least one memory device in the memory may be a volatile memory device or may be a non-volatile memory device.

In addition, in the following description, an “external storage device” may be one or more persistent storage devices, which are an example of one or more storage devices. The persistent storage device may be typically a non-volatile storage device (for example, an auxiliary storage device), and specifically, may be a hard disk drive (HDD), a solid-state drive (SSD), a non-volatile memory express (NVME) drive, or a storage class memory (SCM).

In addition, in the following description, a “storage unit” or an “external storage device” may be a memory out of the memory and a persistent storage device or may be both of the memory and the persistent storage device.

In addition, in the following description, a “processing unit” or a “processor” may be one or more processor devices. At least one of the one or more processor devices may be typically a microprocessor device such as a central processing unit (CPU) or may be another type of processor device such as a graphics processing unit (GPU). At least one of the one or more processor devices may be a single core or multiple cores. At least one of the one or more processor devices may be a processor core. At least one of the one or more processor devices may be a processor device in the broad sense, such as a circuit (for example, a field-programmable gate array (FPGA), a complex programmable logic device (CPLD), or an application specific integrated circuit (ASIC)) that is a collection of gate arrays that are written in a hardware description language and perform a part or all of processing.

In addition, in the following description, a function may be described using an expression “yyy unit”, but the function may be implemented by a processor executing one or more computer programs, or may be implemented by one or more hardware circuits (for example, an FPGA or an ASIC), or may be implemented by a combination thereof. In a case where the function is implemented by the processor executing the program, defined processing is performed using a storage device and/or an interface device or the like as appropriate, and thus the function may be at least a part of the processor. Processing described using a function as the subject may be processing that is performed by the processor or a device having the processor. The program may be installed from a program source. The program source may be a program distribution computer or a computer-readable storage medium (for example, a non-transitory storage medium). The description of each function is merely an example, and a plurality of functions may be combined into one function, or one function may be divided into a plurality of functions.

In addition, in the following description, processing may be described using a “program” or a “processing unit” as the subject, processing described using a program as the subject may be processing that is performed by the processor or a device having the processor. In addition, two or more programs may be implemented as one program, and one program may be implemented as two or more programs.

In addition, in the following description, information obtained as an output in response to an input may be described using an expression “xxx table”, the information may be a table having any structure or may be a learning model represented by a neural network, a genetic algorithm, or a random forest that provides an output in response to an input. Therefore, an “xxx table” can be called “xxx information”. In addition, in the following description, a configuration of each table is an example, one table may be divided into two or more tables, and all or some of two or more tables may be one table.

In addition, in the following description, an “equipment layout adjustment system” may be a system constituted by one or more physical computers or may be a system (for example, a cloud computing system) implemented on a physical computation resource group (for example, a cloud infrastructure). The fact that the equipment layout adjustment system “displays” display information is that the display information is displayed on a display device included in the computer or that the computer transmits the display information to a display computer (in the latter case, the display information is displayed on the display computer).

The embodiments will be described below with reference to the drawings.

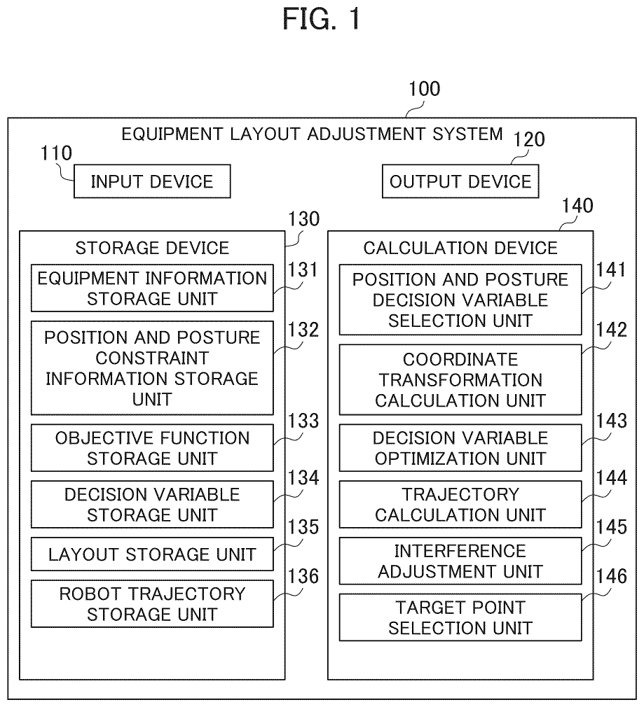

FIG. 1 is a diagram illustrating an example of a configuration of the equipment layout adjustment system.

An equipment layout adjustment system 100 is disposed in a manufacture site (area) or a facility other than the manufacture site. The equipment layout adjustment system 100 includes a group of devices, such as a display computer, that are communicatively connected via a network (not illustrated) and supports a usage environment.

Although not illustrated, the network may be, for example, a local area network (LAN), a wide area network (WAN), a virtual private network (VPN), a communication network that uses general a public line such as the Internet in part or in whole, a mobile phone communication network, or a combination of these networks. The network may be a wireless communication network such as a Wi-Fi (registered trademark) or 5G (Generation) network.

The equipment layout adjustment system 100 includes an input device 110, an output device 120, a storage device 130, and a calculation device 140. The input device 110 and the output device 120 correspond to the “input device” and the “output device” described above, respectively. The storage device 130 corresponds to a “storage unit” or an “external storage device” described above. The calculation device 140 corresponds to a “processing unit” or a “processor” described above.

### <Description of Storage Unit>

The storage device 130 includes an equipment information storage unit 131, a position and posture constraint information storage unit 132, an objective function storage unit 133, a decision variable storage unit 134, a layout storage unit 135, and a robot trajectory storage unit 136.

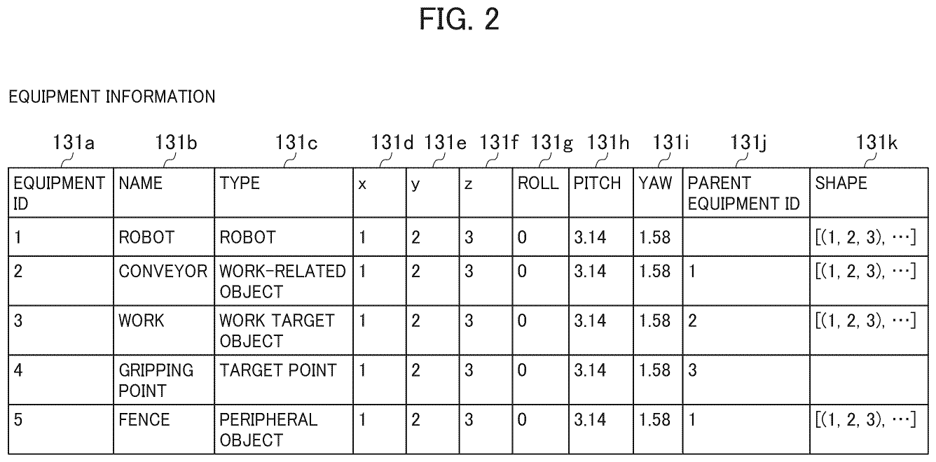

FIG. 2 is a diagram illustrating an example of equipment information stored in the equipment information storage unit 131.

The equipment information includes information indicating a name, a type, a position and a posture, a parent equipment item, and a shape of each equipment item.

As the name of each equipment item, a number or a character string specific to the equipment item is stored in an equipment ID 131a. As the name of each equipment item, a name 131b that is character string information may be stored.

As the type of each equipment item, a type 131c is stored. Examples of the type of each equipment item include a robot, a work target object, a target point, a work-related object, and a peripheral object. The work target object refers to a workpiece or a tool holder on which the robot performs work such as gripping, processing, or tool replacement. The target point refers to the position and the posture of a hand of the robot during work on the work target object. The work-related object refers to an object that is not the work target object but is related to the arrangement of the work target object. The peripheral object refers to an object that is not the work target object and is not related to the arrangement of the work target object.

Generally, constraints on positions and postures arise between the above-described objects. For example, when the work target object is placed on the work-related object or is fixed to the work-related object, the position and the posture of the work target object are constrained due to the position and the posture of the work-related object. Alternatively, the hand of the robot grips or processes the target point, the position and the posture of the hand of the robot are constrained due to the position and the posture of the target point.

For example, in work in which the robot surrounded by a fence uses the hand to pick up and lift the workpiece on the conveyor, the workpiece is the work target object, the gripping point on the workpiece is the target point, the conveyor carrying the workpiece is the work-related object, and the fence is the peripheral object. As another example, when the robot uses a welding gun to perform arc welding on a metal plate fixed to a jig, the metal plate is the work target object, a plurality of points that constitute a welding path on the metal plate are target points, and the jig is the work-related object. As another example, when the robot uses a camera of the hand to visually inspect a product on a pallet placed on a worktable from multiple viewpoints in a dark room, the product is the work target object, the pallet and the worktable are work-related objects, and the darkroom is the peripheral object, and all of postures of the camera relative to the product during the inspection are target points.

In addition, the position of each equipment item is stored in x131d, y131e, and z131f as values in a Cartesian coordinate system, and the posture of each equipment item is stored in roll 131g, pitch 131h, and yaw 131i as rotations around the axes of the Cartesian coordinate system. The posture may be stored using another expression method such as a quaternion or a rotation matrix.

In addition, a parent equipment ID 131j indicating a parent equipment item which is a parent of the coordinate system is stored. In this case, the presence of a parent-child relationship between a coordinate system of a certain equipment item and a coordinate system of another equipment item indicates that the two coordinate systems are different and that a transformation matrix is provided to convert coordinate values between the two coordinate systems. In a case where a parent equipment item is not present, a field can be left blank or a reserved word such as “world” can be used to indicate that a parent equipment item is not present and that world coordinates are used as a coordinate system. For example, in the present embodiment, the parent equipment item of the robot is blank, and thus a coordinate system of the robot is a world coordinate system.

In addition, a set of vectors indicating points on a surface of a triangle mesh as a shape of each equipment item and the inside and outside of the equipment item is stored in a shape 131k. As a general three-dimensional shape format, the shape 131k may be stored as a mathematical representation of a point, a vector and a curve in a three-dimensional space, such as a wireframe or a quadrilateral mesh. In a case where the type 131c is a target point, nothing is input to the shape 131k, or only the coordinates of a point representing the origin are input.

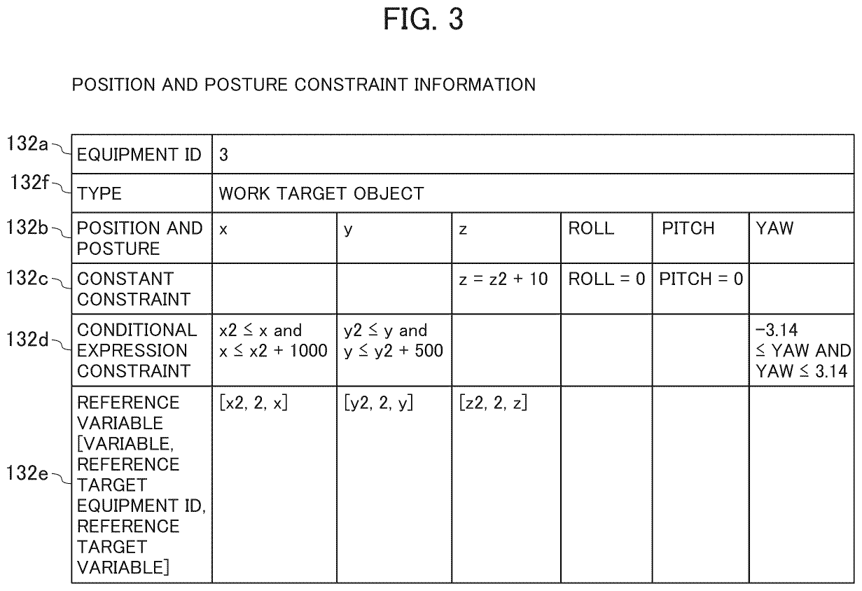

FIG. 3 is a diagram illustrating an example of position and posture constraint information stored in the position and posture constraint information storage unit 132.

In the position and posture constraint information, constraints on parameters that represent the position and the posture of each equipment item are stored. A number or a character string that distinguishes the equipment items is stored in an equipment ID 132a. The equipment ID 132a corresponds to the equipment ID 131a. The type 131c of equipment information indicated by the equipment ID 132a is referenced and the value of the type 131c is stored in a type 132f. Although the type 132f is provided for explanation, the equipment information storage unit 131 may be referenced each time in the embodiment. The type 132f of the position and posture constraint information indicates the work target object or the work-related object, but may indicate a target point or a peripheral object as described later.

In addition, the contents of parameters for the position and the posture are stored in a position and posture 132b. The parameters for the position and the posture may be expressed in the same expression method as the positions and postures of the equipment items, or in another method that can mutually be transformed. In addition, in a case where a parameter can only take a certain constant as a constraint, the constant is stored in a constant constraint 132c.

The type 132f may be a target point. For example, when the robot grips a parallel surface of a workpiece with a two-jaw gripper, it can be expressed that a gripping point (for example, the target point) has a degree of freedom on the parallel surface, and the angle of the gripper also has a degree of freedom along the parallel surface. In a case where the positions and postures of the gripper and the workpiece are present as decision variables, the number of decision variables increases compared to a case where a posture for the gripping is fixed, and thus a search range is widened. For example, an objective function input by a user is minimization of the cycle time, there is a possibility that a solution with a shorter cycle time may be found.

The type 132f may be the peripheral object. For example, it is possible to express that the fence (i.e., the peripheral object) surrounding the robot has a degree of freedom to move by several tens of centimeters away from the robot, a tool table can be placed between the fence and the robot, the number of decision variables increases compared to a case where the position and the posture of the peripheral object are fixed, and thus a search range is widened.

As a constraint, either one or both of an upper limit value and a lower limit value for the parameter may be stored in a conditional expression constraint 132d. For example, a range in which the pallet can be moved on the worktable can be expressed by the length and width of a top plate. This allows the pallet to be moved within a range where the pallet does not fall off from the worktable and place the pallet in a position where the robot easily performs work.

A parameter for another equipment item may be referenced as a variable in the constant constraint 132c or the conditional expression constraint 132d, and none of or one or more of a character string of the variable, a reference target equipment ID, and a reference target parameter for a position and a posture may be stored in a reference variable 132e. For example, the position of the conveyor when a leading edge of the conveyor needs to contact the worktable can be expressed as a constant with reference to the position of the worktable.

The example illustrated in FIG. 3 will be described. In the example illustrated in FIG. 3, the equipment ID 132a is 3, and the type 132f is the work target object. This indicates that the position and posture constraint information illustrated in FIG. 3 is related to the work target object (i.e., the workpiece). In this case, the fact that the parent equipment item of the workpiece is the conveyor is identified (that is, the workpiece of which the position and the posture are constrained is placed on the conveyor.

As the position and posture 132b, x, y, z, roll, pitch, and yaw are stored, and the constant constraint 132c is set for z, roll and pitch among them. Specifically, regarding roll and pitch, roll=0 and pitch=0 are set. This indicates that the workpiece is placed on the conveyor and roll (i.e., rotation around the x axis) and pitch (i.e., rotation around the y axis) are constrained to constant values (both are 0 in this example).

Meanwhile, regarding z, z=z2+10 is set. In this case, z indicates a z coordinate value in a coordinate system of the workpiece, and z2 indicates a z coordinate value in a coordinate system of the conveyor. [z2, 2, z] of the reference variable 132e indicates these values. In addition, z=z2+10 indicates that the z coordinate value in the coordinate system of the workpiece is equal to a value obtained by adding 10 to the z coordinate value in the coordinate system of the conveyor. This indicates that since the workpiece is placed on the conveyor, the position of the workpiece in the z axis direction is constrained due to the position of the conveyor in the z axis direction, in other words, the position of the workpiece in the z axis direction depends on the position of the conveyor in the z axis direction. That is, the coordinate value of the work piece in the z axis direction is not independent of the coordinate value of the conveyor in the z axis direction, and the coordinate value of the workpiece in the z axis direction is determined when the coordinate value of the conveyor in the z axis direction is determined.

Therefore, the values of roll and pitch of the workpiece are constant in optimization calculation, the z coordinate value does not need to be treated as an independent variable, thus the number of variables for the optimization calculation is reduced, and as a result, the amount of the calculation is reduced.

For x, y, and yaw, the conditional expression constraint 132d is set. Specifically, regarding x, x2≤x and x≤x2+1000 are set. In this case, x indicates the x coordinate value in the coordinate system of the workpiece and x2 indicates the x coordinate value in the coordinate system of the conveyor. [x2, 2, x] of the reference variable 132e indicates these values. In addition, x2≤x and x≤x2+1000 indicate that the coordinate value x of the workpiece in the x axis direction is any value in a range from the coordinate value x2 of the conveyor in the x axis direction to x2+1000. In this example, the x axis direction is the direction in which the workpiece is transported by the conveyor, and 1000 indicates a length of a range in which the workpiece can be transported by the conveyor.

Similarly, regarding y, y2≤y and y≤y2+500 are set. In this case, y indicates the x coordinate value in the coordinate system of the workpiece and y2 indicates the y coordinate value in the coordinate system of the conveyor. [y2, 2, y] of the reference variable 132e indicate these values. In addition, y2≤y and y≤y2+500 indicate that the coordinate value y of the workpiece in the y axis direction is any value in a range from the coordinate value y2 of the conveyor in the y axis direction to y2+500. In this example, the y axis direction is a width direction of the conveyor, and 500 indicates a length of a range which is in the width direction and in which the workpiece can be placed on the conveyor.

As described above, it is possible to prevent an unnecessary increase in the amount of the calculation by limiting, based on a positional relationship with the conveyor, ranges in which x and y can take values, and excluding, from the calculation, positions that are not actually possible in the optimization calculation.

Regarding yaw, −3.14≤yaw and yaw ≤3.14 are set. This indicates that the rotation (i.e., yaw) of the workpiece around the z axis is not constrained and that any posture in a range from −180° to +180° can be taken. When no constraint is present, for example, yaw of the workpiece can be set to 540°, but this is the same as 180°, such a value is not accepted, yaw is limited to a range from −180° to +180°, and thus it is possible to prevent an unnecessary increase in the amount of the calculation in the optimization calculation.

Return to FIG. 1. The objective function storage unit 133 stores an objective function for the optimization calculation as a character string of a calculation formula, and stores whether the objective function is to be maximized or minimized as binary data such as Boolean. The objective function may be a function of evaluating the efficiency, cost, or safety of the operation of the robot, for example. As a specific example of the objective function, minimizing the cycle time or minimizing a joint load of the robot can be considered.

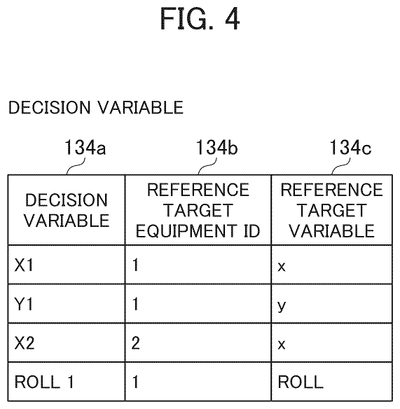

FIG. 4 is a diagram illustrating an example of decision variables stored in the decision variable storage unit 134.

The decision variable storage unit 134 stores a decision variable 134a for the optimization calculation, a reference target equipment ID 134b for the decision variable, and a reference target variable 134c.

For example, as illustrated in FIG. 4, when X1, 1, and x are stored as the decision variable 134a, the reference target equipment ID 134b, and the reference target variable 134c, respectively, the decision variable X1 for the optimization calculation corresponds to x in the coordinate system of the robot with the equipment ID indicating 1. Similarly, when X2, 2, and x are stored as the decision variable 134a, the reference target equipment ID 134b, and the reference target variable 134c, respectively, the decision variable X2 for the optimization calculation corresponds to x in the coordinate system of the conveyor with the equipment ID indicating 2. Since a plurality of values such as x, y, and z in the coordinate system are used in the optimization calculation, such a new decision variable is defined to distinguish those values and is associated with a reference target variable.

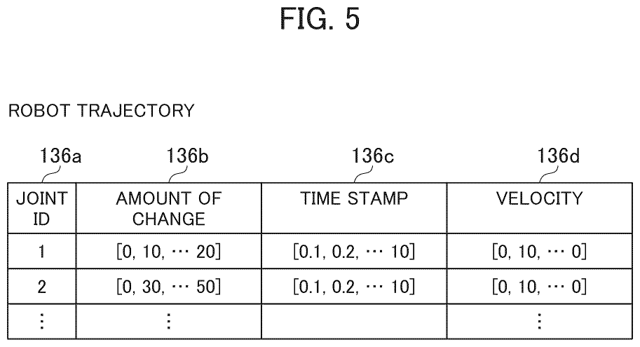

FIG. 5 is a diagram illustrating an example of a robot's trajectory stored in the robot trajectory storage unit 136.

The robot trajectory storage unit stores a joint ID 136a of the robot, and an amount 136b of change in a joint that is expressed as a series of discrete values representing the movement of the joint. In addition, a time stamp 136c expressed as a series of points of time corresponding to the discrete values representing the movement of the joint may be included. Further, a velocity 136d of the joint that corresponds to the discrete values representing the movement of the joint may be included.

Return to FIG. 1. The layout storage unit 135 stores the position and the posture of each equipment item. The format of the position and the posture in the layout storage unit is the same as the format of the positions and postures of the equipment information, and thus illustration thereof is omitted.

### <Description of Processing Unit>

Return to FIG. 1. The calculation device 140 includes a position and posture decision variable selection unit 141, a coordinate transformation calculation unit 142, a decision variable optimization unit 143, a trajectory calculation unit 144, an interference adjustment unit 145 and a target point selection unit 146.

The position and posture decision variable selection unit 141 sets, as a candidate for a decision variable, a parameter for the position and the posture of each equipment item stored in the equipment information storage unit 131 and selects a decision variable using the position and posture constraint information stored in the position and posture constraint information storage unit 132. A method for the selection will be described later. The selected decision variable is stored in the decision variable storage unit 134.

The coordinate transformation calculation unit 142 calculates a matrix for coordination transformation from the coordinates of the robot to the target point using information of the position and the posture of each equipment item and the parent equipment item stored in the equipment information storage unit 131, and the decision variable stored in the decision variable storage unit 134.

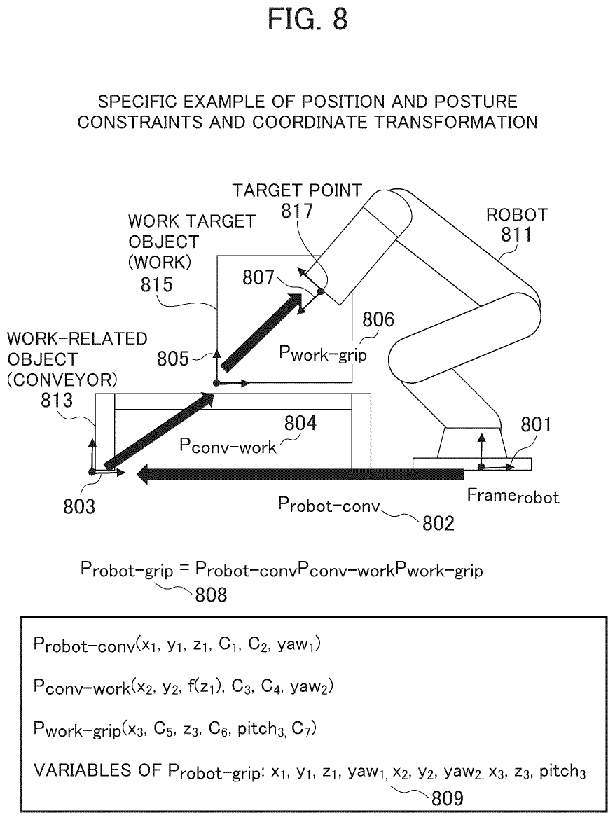

FIG. 8 is a diagram illustrating an example of coordinate transformation from robot coordinates to the target point using decision variables.

As a specific example, a robot 811, a conveyor 813 which is an example of the work-related object, a workpiece 815 which is an example of the work target object and is placed on the conveyor 813, and a target point 817 which is an example of the target point and is on the workpiece are considered. A matrix 802 (P_{robot-conv}) for coordinate transformation from a robot coordinate system 801 to a convey coordinate system 803, a matrix 804 (P_{conv-work}) for coordinate transformation from the convey coordinate system 803 to a workpiece coordinate system 805, a matrix 806 (P_{work-grip}) for coordinate transformation from the workpiece coordinate system 805 to a target point coordinate system 807 are multiplied to obtain a matrix 808 for coordinate transformation from the robot coordinate system to the target point coordinate system in order. When the matrices 802, 804, and 806 for coordinate transformation are expressed by decision variables and parameters replaced with constants due to constant constraints, variables of the matrix 808 (P_{robot-grip}) for coordinate transformation are only decision variables 809.

For example, variables of the matrix 804 (P_{conv-work}) for coordinate transformation from the convey coordinate system 803 to the workpiece coordinate system 805 are originally six variables which are x, y, z, roll, pitch, and yaw. However, as illustrated in FIG. 3, roll and pitch are replaced with constants, and z is replaced with a function of referencing the z coordinate value of the coordinate system of the conveyor that is the parent equipment item. Therefore, the number of variables is reduced by 3. Although x, y, and yaw remain as variables, but ranges of values that the variables take are constrained.

Similarly, the numbers of decision variables of the matrix 802 (P_{robot-conv}) for coordinate transformation and the matrix 806 (P_{work-grip}) for coordinate transformation are reduced by replacing decision variables with constants or functions of other variables, and the number of decision variables 809 of the matrix 808 (P_{robot-grip}) for coordinate transformation is reduced to 10.

Return to FIG. 1. The decision variable optimization unit 143 optimizes the decision variable stored in the decision variable storage unit 134 for the objective function stored in the objective function storage unit 133, and stores the position and the posture of each equipment item to the layout storage unit 135 using the optimized decision variable, the equipment information, and the position and posture constraint information. The objective function is involved in the trajectory of the robot, and thus the trajectory calculation unit 144 plans a trajectory for each candidate for the decision variable.

In this case, since the decision variable is constrained by the position and posture constraint information, the trajectory calculation unit 144 plans a trajectory based on a variable for a position and a posture within a range constrained in accordance with the position and posture constraint information. The decision variable optimization unit 143 evaluates the objective function based on the trajectory. As described above, the amount of calculation required for the optimization can be reduced by excluding a variable replaced with a constant from decision variables, not requiring to treat, as an independent variable, a variable replaced with a function of referencing another variable, and excluding, from the calculation, a value that is for a variable in a determined range and is out of the range.

General methods such as Newton's algorithm and gradient descent can be used as a method for the optimization, and therefore detailed description thereof is omitted.

The trajectory calculation unit 144 uses Inverse Kinematics (IK) to calculate the posture of the robot, which approaches the target point, from the matrix calculated by the coordinate transformation calculation unit 142 and provided for coordinate transformation from the coordinates of the robot to the target point, and calculates a trajectory from the target point to the target point. A general method such as a rapidly-exploring random tree (RRT) can be used as a method for calculating the trajectory, and therefore detailed description thereof is omitted.

The interference adjustment unit 145 performs coordinate transformation on information of the shapes indicated in the equipment information by recursively tracing a decision variable, information of the positions and the postures, and information of parent equipment items, and determines interference between the equipment items for the decision variable. When the interference is present, the interference adjustment unit 145 discards a candidate for the decision variable from candidates and performs optimization of the decision variable again.

In addition, when the interference is present, the peripheral object, the work-related object, and the work target object may be moved in this order in a direction where the interference is eliminated within a range in which the positions and the postures are constrained. In this case, the movement of the peripheral object is stored in the equipment information storage unit 131. In the case of the movement of the work-related object and the work target object, candidates for the decision variable are rewritten. For example, when the conveyor which is the work-related object and the fence which is the peripheral object interfere with each other, and the interfere is eliminated by moving the fence within a range in which the position and posture are constrained, the fence is moved and thus a layout that does not affect the trajectory of the robot can be implemented.

In a case where a plurality of target points stored in the equipment information storage unit 131 have a common parent equipment ID and are located at a distance equal to or less than a certain distance in a three-dimensional space or a robot posture space, the target point selection unit 146 adds a constant position and posture constraint for which the position and the posture of another target point are referenced to a parameter that does not have a constant position and posture constraint among parameters of the positions and postures of the target points. For example, when a plurality of screws are tightened to assemble a component, a driver is orthogonal to a screw hole at a target point in a screw tightening operation, but has a degree of freedom to rotate around the screw axis. In a case where a distance between screw holes is short, screw tightening postures of a robot will also be close. Thus, by determining the position and the posture of a target point for a representative screw hole, it is highly likely that similar target points can be adopted for other screw holes. Therefore, instead of using a degree of freedom as a decision variable for all screw holes, by allowing a degree of freedom to rotate only the target point of the representative screw hole, and adding position and posture constraint information from which the rotation of the representative target point around the screw hole is referenced for rotation around screw axes of other screw holes, it is possible to reduce the number of decision variables and simplify the calculation.

### <Description of Main Flowchart>

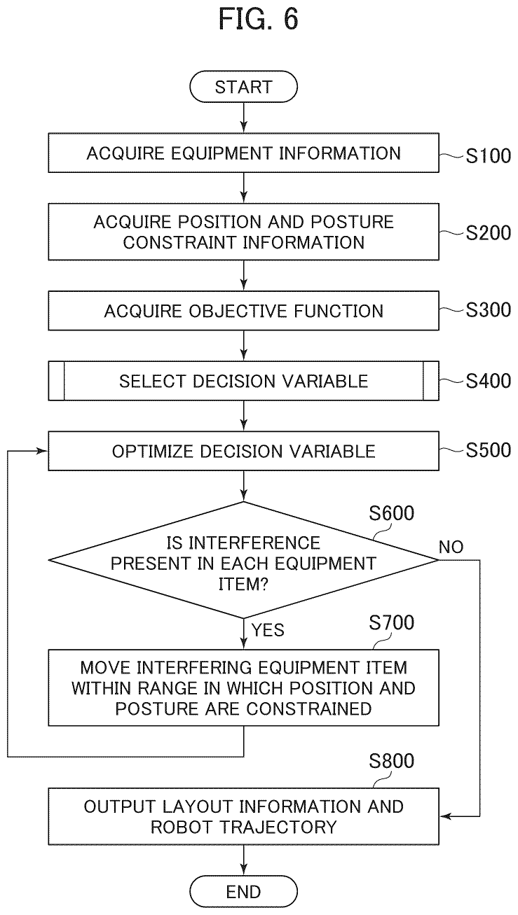

FIG. 6 is a flowchart illustrating an example of an equipment layout adjustment process.

First, the input device 110 acquires the equipment information from the user (step S100). Equipment information is stored in the equipment information storage unit 131.

Next, the input device 110 acquires the position and posture constraint information (step S200). In this case, for an equipment item for which position and posture constraint information could not be acquired among equipment items stored in the equipment information storage unit 131, position and posture constraint information in which positions and postures 131d to 131i are input to the constant constraint 132c is created. For example, in a case where position and posture constraint information for the target point cannot be acquired, position and posture constraint information is created, which indicates that movement from the position and the posture of the target point input as equipment information is not permitted. The position and posture constraint information is stored in the position and posture constraint information storage unit 132.

In addition, in step S200, the target point selection unit 146 may acquire, from a user input, a single representative target point among a plurality of target points that are within a certain distance and whose parent equipment IDs are the same work target object, or automatically select a single representative target point from among the plurality of target points using a work order or a distance as a reference, and add a position and posture constraint for which a position and a posture of the representative target point is referenced such that position and posture constraints on the other target points are all constant constraints.

Next, the input device 110 acquires the objective function (step S300). The objective function is stored in the objective function storage unit 133.

Next, the position and posture decision variable selection unit 141 selects a decision variable and stores the selected decision variable to the decision variable storage unit 134 (step S400). Details will be described later.

Next, the decision variable optimization unit 143 optimizes the decision variable for the objective function (step S500). The processing by the decision variable optimization unit 143 is described above, and description thereof is omitted.

Next, the interference adjustment unit 145 determines interference of each equipment item, and returns the process to step S500 when interference is present. When interference is not present, the process proceeds to step S800 (step S600). When interference is present in step S600, the interference adjustment unit 145 may move an interfering equipment item in a direction where the interference is eliminated, and return the process to step S500 (step S700). The processing by the interference adjustment unit 145 has already been described above, and description thereof is omitted.

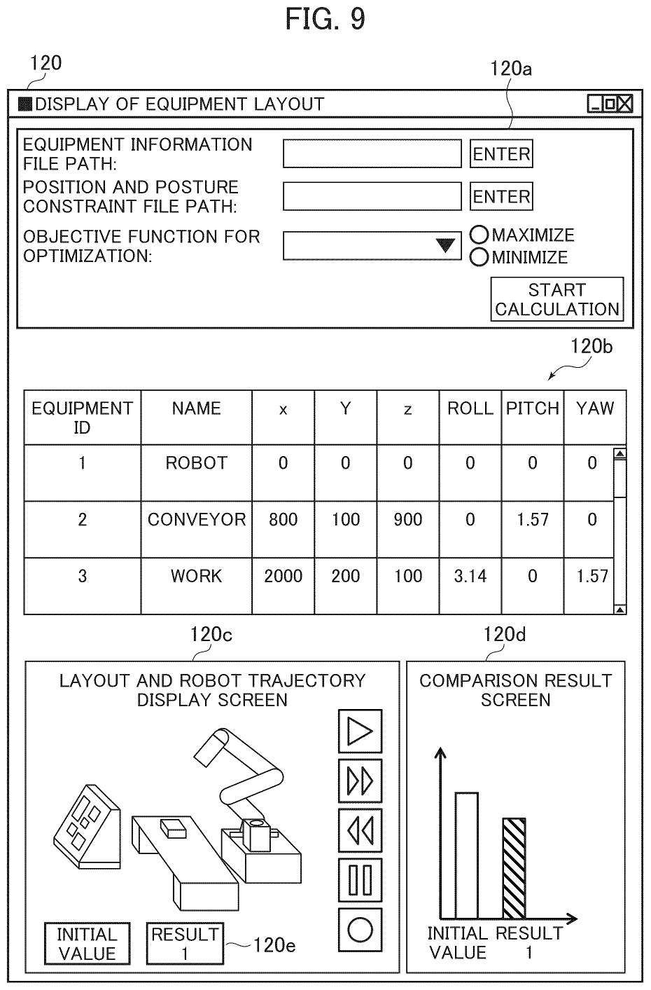

Next, the position and the posture of each equipment item are stored in the layout storage unit 135, and a trajectory of the robot is stored in the robot trajectory storage unit 136 (step S800). The output device of the equipment layout adjustment system 100 may display a screen indicating the arrangement of each equipment item based on the stored position and posture of each equipment item and a screen indicating a trajectory of the robot for the arrangement. An example of the displayed screens will be described later (see FIG. 9).

### <Description of Decision Variable Selection Process Flowchart>

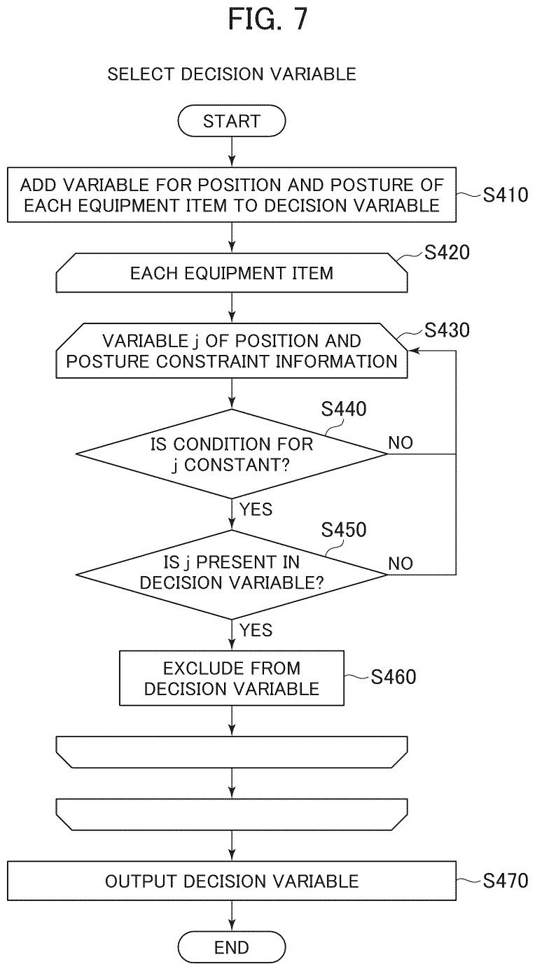

FIG. 7 is a flowchart illustrating an example of a decision variable selection process (Step S400).

The position and posture decision viable selection unit 141 sets, as a candidate for a decision variable, a parameter for the position and the posture of each equipment item stored in the equipment information storage unit 131 (step S410).

Next, the position and posture decision variable selection unit 141 starts a loop for each equipment item stored in the equipment information storage unit 131 (step S420).

Next, the position and posture decision variable selection unit 141 starts a loop for a parameter j for the position and the posture in the position and posture constraint information stored in the position and posture constraint information storage unit 132 (step S430).

Next, the position and posture decision variable selection unit 141 determines whether the parameter j includes a constant constraint (step S440). In a case where the parameter j includes the constant constraint, the process returns to step S430.

In a case where the parameter j includes the constant constraint (step S440: Yes), the position and posture decision variable selection unit 141 determines whether the parameter j is present as a candidate for the decision variable (step S450). In a case where the parameter j is not present, the process returns to step S430.

In a case where the parameter j is present as a candidate for the decision variable (step S450: Yes), the position and posture decision variable selection unit 141 excludes the parameter j from a candidate for the decision variable (step S460). After that, the process returns to step S430.

Next, in a state in which the loops in S420 and S430 are completed, a parameter remaining as a candidate for the decision variable is stored as the decision variable in the decision variable storage unit 134 (step S470).

For example, in the position and posture constraint information illustrated in FIG. 3, roll and pitch among variables for the position and the posture of the workpiece are constants, and are excluded from the decision variables (step S460). x, y, z and yaw other than roll and pitch are output as decision variables (step S470).

### <Description of Example of Output Display>

FIG. 9 is a diagram illustrating an example of display screens output by the output device 120.

Display screens output by the output device 120 include a screen 120a displayed for receiving data input from the user via the input device 110, a table 120b for an equipment layout output by the output device 120, and a layout and robot trajectory display screen 120c. In addition, the display screens may include a comparison result screen 120d for an objective function.

For example, on the layout and robot trajectory display screen 120c, the arrangement of the robot, the conveyor, and the like, and a robot's trajectory calculated for the arrangement are displayed. When the user presses a button for displaying initial values, initial arrangement and an initial trajectory may be displayed. When the user presses a button for displaying a result of optimization, arrangement and a trajectory after the optimization may be displayed. In addition, the trajectory of the robot may be displayed as a video image of the robot moving on a displayed screen may be displayed. The user can operate the screen and display the postures of the robot and the workpiece at any point of time. The user can reference this and compare cost benefits between a case where an existing equipment item is reused and a case where a new equipment item is purchased, or compare cost benefits between a case where the current equipment items are not modified and a case where modifications to the current equipment items are permitted. As a specific example, in a case where the conveyor and the robot are fixed in a factory, it is possible to consider the cost of re-fixing the conveyor and the benefit given to the objective function by comparing a case where the position of the conveyor is fixed as it is with a case where the position and the posture of the conveyor are given degrees of freedom on the assumption that the conveyor is re-fixed to a floor.

In addition, the layout and robot trajectory display screen 120c may include a button 120e for comparing results. When the user operates the button 120e, an objective function (“result 1” in the example illustrated in FIG. 9) calculated based on the arrangement after optimization is displayed for an initial value of the objective function calculated based on initial arrangement of the robot, the conveyor, and the like.

The configuration of the equipment layout adjustment system 100 according to the present embodiment is described above. The equipment layout adjustment system 100 can narrow down candidates for layout decision variables and reduce the amount of the calculation while considering not only a work target but also the positions and postures of objects related to the work target. That is, it is possible to provide the technique for adjusting the layout of the equipment items including the robot in a simple manner.

In addition, the system according to the embodiment of the present invention may be configured as follows.

(1) An equipment layout adjustment system (for example, the equipment layout adjustment system 100) includes a calculation device (for example, the calculation device 140) and a storage device (for example, the storage device 130). The storage device holds position and posture constraint information (for example, the position and posture constraint information (FIG. 3) stored in the position and posture constraint information storage unit 132) indicating a constraint on a position and a posture of an object. The object includes at least a robot (for example, the robot 811) and a work target object (for example, the work target object 815) that is a target on which the robot performs work, and a work-related object (for example, the work-related object 813) that constrains a position and a posture of the work target object. The calculation device selects a decision variable to be subjected to calculation for optimization of an objective function of evaluating an operation of the robot from among variables indicating the position and the posture of the object (for example, step S400), calculates a trajectory of the robot based on the decision variable (for example, the processing by the trajectory calculation unit 144 in step S500), and specifies, based on the calculated trajectory of the robot, a value of the decision variable so as to optimize the objective function (for example, the processing by the decision variable optimization unit 143 in step S500).

Therefore, it is possible to adjust the layout of the equipment items including the robot in a simple manner.

(2) In the equipment layout adjustment system described in (1) described above, the position and posture constraint information holds a variable (for example, roll and pitch in the example illustrated in FIG. 3) constrained to a predetermined value due to a relationship with another object and replaced with a constant among the variables indicating the position and the posture of the object, and the calculation device selects, as the decision variable, a variable other than the variable replaced with the constant from among the variables indicating the position and the posture of the object (for example, steps S440, S450, S460, and S470).

Therefore, the number of variables to be subjected to the optimization calculation is reduced.

(3) In the equipment layout adjustment system described in (2) described above, the position and posture constraint information holds a variable (for example, z in the example illustrated in FIG. 3) depending on a variable indicating a position and a posture of the other object due to the relationship with the other object among the variables indicating the position and the posture of the object in a format in which the variable indicating the position and the posture of the other object is referenced.

Therefore, the number of variables to be subjected to the optimization calculation is reduced and the amount of the calculation is reduced.

(4) In the equipment layout adjustment system described in (2) described above, the position and posture constraint information holds a predetermined range for a variable (for example, x, y and yaw in the example illustrated in FIG. 3) constrained to a value in the predetermined range due to the relationship with the other object among the variables indicating the position and the posture of the object.

Therefore, the range of the variable to be subjected to the optimization calculation is constrained and the amount of the calculation is reduced.

(5) In the equipment layout adjustment system described in (2) described above, the position and posture constraint information includes a constraint on a position and a posture of a target point of a hand of the robot on the work target object, and the calculation device selects, based on the position and posture constraint information, a decision variable to be subjected to calculation for optimization of a predetermined objective function from among variables indicating positions and postures of the object and the target point.

Therefore, it is possible to adjust the layout of the equipment items including the robot in addition to the position and the posture of the target point on the work target object in a simple manner.

(6) In the equipment layout adjustment system described in (5) described above, when a plurality of target points are present on the work target object, and a distance between the plurality of target point satisfies a predetermined condition, the position and posture constraint information holds a variable indicating a position and a posture of a target point other than a first target point among the plurality of target points in a format in which a variable indicating a position and a posture of the first target point is referenced.

Therefore, even when a plurality of target points are present on the work target object, it is possible to adjust the layout of the equipment items including the robot in a simple manner.

(7) In the equipment layout adjustment system described in (1) described above, the position and posture constraint information further includes a constraint on a position and a posture of a peripheral object (for example, the fence or the like) not corresponding to any one of the robot, the work target object, and the work-related object, the calculation device determines, based on the value of the decision variable and the calculated trajectory of the robot, whether at least any one of the robot, the work target object, and the work-related object interferes with the peripheral object (for example, step S600), and when the calculation device determines that the interference occurs, the calculation device changes the position and the posture of the peripheral object within a range of the constraint (for example, S700).

Therefore, it is possible to adjust the layout of the equipment items in a simple manner in addition to the arrangement of the peripheral object that is not directly involved in the work.

(8) The equipment layout adjustment system described in (1) described above further includes an output device (for example, the output device 120), wherein the output device outputs a screen (for example, the comparison result screen 120d for the objective function) displaying a value of the objective function calculated based on each of initial values and optimized values of the variables indicating the position and the posture of the object.

Therefore, a user can easily compare layouts and trajectories of the robot before and after the optimization.

(9) The equipment layout adjustment system described in (1) described above further includes an output device, wherein the output device outputs a screen (for example, the layout and robot trajectory display screen 120c) displaying the position and the posture of the object based on each of initial values and optimized values of the variables indicating the position and the posture of the object.

Therefore, the user can easily compare values of the objective function before and after the optimization.

(10) In the equipment layout adjustment system described in (1) described above, the objective function includes at least any one of a cycle time and a joint load of the robot.

Therefore, it is possible to adjust the layout of the equipment items such that at least any one of the cycle time and the joint load is minimized.

It should be noted that the present invention is not limited to the embodiments described above, and includes various modification. For example, the embodiments described above have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

In addition, some or all of the configurations, the functions, the processing units, the processing means described above may be implemented with hardware by design with an integrated circuit or the like. Further, each of the configurations, the functions, and the like described above may be implemented with software by the processor interpreting the program for implementing each of the functions and executing the program. Information of the program for implementing each of the functions, the tables, files, and the like can be stored in a storage device such as a non-volatile semiconductor memory, a hard disk drive, or a solid-state drive (SSD) or a non-transitory computer-readable data storage medium such as an IC card, an SD card, or a DVD.

In addition, the control lines and the information lines are considered necessary for the explanation, and all of control lines and information lines on the product may not be necessarily illustrated. Actually, almost all components are considered to be connected to each other.

In addition, the technical elements in the embodiments described above may be applied singly or may be applied in the form of multiple components, such as a program component and a hardware component.

### LIST OF REFERENCE SIGNS

100: equipment layout adjustment system
110: input device
120: output device
130: storage device
131: equipment information storage unit
132: posture constraint information storage unit
133: objective function storage unit
134: decision variable storage unit
135: layout storage unit
136: robot trajectory storage unit
140: calculation device
141: position and posture decision variable selection unit
142: coordinate transformation calculation unit
143: decision variable optimization unit
144: trajectory calculation unit
145: interference adjustment unit
146: target point selection unit

1. An equipment layout adjustment system comprising:
a calculation device; and
a storage device, wherein
the storage device holds position and posture constraint information indicating a constraint on a position and a posture of an object,
the object includes at least a robot, a work target object that is a target on which the robot performs work, and a work-related object that constrains a position and a posture of the work target object,
the calculation device
selects, based on the position and posture constraint information, a decision variable to be subjected to calculation for optimization of an objective function of evaluating an operation of the robot from among variables indicating the position and the posture of the object,
calculates a trajectory of the robot based on the decision variable, and
specifies, based on the calculated trajectory of the robot, a value of the decision variable so as to optimize the objective function.

2. The equipment layout adjustment system according to claim 1, wherein
the position and posture constraint information holds a variable constrained to a predetermined value and replaced with a constant due to a relationship with another object among variables indicating the position and the posture of the object, and
the calculation device selects, as the decision variable, a variable other than the variable replaced with the constant from among the variables indicating the position and the posture of the object.

3. The equipment layout adjustment system according to claim 2, wherein
the position and posture constraint information holds a variable that depends on a variable indicating a position and a posture of another object due to the relationship with the other object among the variables indicating the position and the posture of the object in a format in which the variable indicating the position and the posture of the other object is referenced.

4. The equipment layout adjustment system according to claim 2, wherein
the position and posture constraint information holds a predetermined range for a variable constrained to a value in the predetermined range due to the relationship with the other object among the variables indicating the position and the posture of the object.

5. The equipment layout adjustment system according to claim 2, wherein
the position and posture constraint information further includes a constraint on a position and a posture of a target point of a hand of the robot on the work target object, and
the calculation device selects, based on the position and posture constraint information, a decision variable to be subjected to calculation for optimization of a predetermined objective function from among variables indicating the positions and the postures of the object and the target point.

6. The equipment layout adjustment system according to claim 5, wherein
when a plurality of target points on the work target object are present, and a distance between the plurality of target points satisfies a predetermined condition, the position and posture constraint information holds a variable indicating a position and a posture of a target point other than a first target point among the plurality of target points in a format in which a variable indicating a position and a posture of the first target point is referenced.

7. The equipment layout adjustment system according to claim 1, wherein
the position and posture constraint information includes a constraint on a position and a posture of a peripheral object not corresponding to any one of the work target object and the work-related object, and
the calculation device determines, based on the value of the decision variable and the calculated trajectory of the robot, at least any one of the robot, the work target object, and the work-related object interferes with the peripheral object, and when the calculation device determines that the interference occurs, the calculation device changes the position and the posture of the peripheral object within a range of the constraint.

8. The equipment layout adjustment system according to claim 1, further comprising:
an output device, wherein
the output device outputs a screen on which a value of the objective function calculated based on initial values and optimized values of the variables indicating the position and the posture of the object is displayed.

9. The equipment layout adjustment system according to claim 1, further comprising:
an output device, wherein
the output device outputs a screen on which the position and the posture of the object calculated based on initial values and optimized values of the variables indicating the position and the posture of the object is displayed.

10. The equipment layout adjustment system according to claim 1, wherein
the objective function includes at least any one of a cycle time and a joint load of the robot.

11. An equipment layout adjustment method that is performed by an equipment layout adjustment system, wherein
the equipment layout adjustment system includes a calculation device and a storage device,
the storage device holds position and posture constraint information indicating a constraint on a position and a posture of an object,
the object includes at least a robot, a work target object on which the robot performs work, and a work-related object that constrains a position and a posture of the work target object, and
the equipment layout adjustment method comprises:
a procedure of causing the calculation device to select, based on the position and posture constraint information, a decision variable to be subjected to calculation for optimization of an objective function of evaluating an operation of the robot from among variables indicating the position and the posture of the object;
a procedure of causing the calculation device to calculate a trajectory of the robot based on the decision variable; and
a procedure of causing the calculation device to specify, based on the calculated trajectory of the robot, a value of the decision variable so as to optimize the objective function.
